(19) United States
(12) Patent Application Publication
(10) Pub. No.: US 2003/0204405 A1
(43) Pub. Date: Oct. 30, 2003

(54) Apparatus and method for providing modular conversation policies for agents

(75) Inventors: James Edwin Hanson, Yorktown Heights, NY (US); David William Levine, New York, NY (US); Prabir Nandi, Symrna, GA (US)

Correspondence Address: Duke W. Yee, Carstens, Yee and Cahoon, L.L.P., P.O. Box 802334, Dallas, TX, 75380, US

(73) Assignee: International Business Machines Corporation, Armonk, NY

(21) Appl. No.: 10/128,864

(22) Filed: Apr. 24, 2002

(51) Int. Cl. G06F 17/60

(52) U.S. Cl. 705/1

(57) ABSTRACT

An apparatus and method for providing modular conversation policies to agents are provided. The apparatus and method provide a mechanism by which conversation policies are implemented in a modular manner such that modification and personalization of the conversation policies to a particular application in an electronic business system is possible. With the apparatus and method, the conversation policies are implemented as objects that may be downloadable and pluggable into existing electronic business systems. Thus, the apparatus and method allow conversation policies to be obtained from third parties and easily integrated into an established electronic business system.

### BACKGROUND OF THE INVENTION

1. Technical Field

The present invention is generally directed to network computing systems. More specifically, the present invention is directed to an apparatus and method for providing modular conversation policies for agents in a network computing system.

2. Description of Related Art

In multi-agent systems, agents interact by sending messages to each other. Each agent is responsible for correctly parsing and acting on the messages it receives. Furthermore, agents tend to carry on extended interacts in which any number of messages are passed back and forth. For example, in a negotiation where one agent acts as a seller of some good or service, and another acts as a buyer, the two agents might exchange offers, counter offers, and other information as part of the negotiation. Such interactions are inherently stateful, i.e. the content of the earlier messages constrains or partially determines the content of possible messages later on.

The same is true of business-to-business interactions among electronic business systems, and among application-to-application interactions in an enterprise application integration system. For purposes of the present description, these are synonymous with “agent”.

In order for such interactions to reliably achieve the effects intended by the agents' programmers, the two agents follow a common protocol. That is, a common protocol defining the set of possible messages and their possible content, that may be sent by either party at each point in a given interaction. This common protocol may range from the very short (even as short as one message) to open-ended protocols of unlimited length. They may be highly constrained, dictating the exact sequence of messages that must be exchanged, or relatively unconstrained, allowing the agents to choose among a wide range of possible messages at any given point in the interaction.

Regardless of whether the common protocol is constrained or unconstrained, open-ended or very short, both agents must operate under the same common protocol. Thus, there is a rigidity in the way in which agents interact with one another and limitations as to which agents can interact with which other agents. That is, because both agents must operate under the same common protocol, agents can only interact with other agents that implement that protocol. Furthermore, even if this common protocol is unconstrained, there is still a limit as to what messages may be sent between the agents, defined by the metes and bounds of the protocol employed. Moreover, since both agents must operate under the same common protocol, if any changes are made to a common protocol, the changes must be made to both agents in order to allow for the interaction to reliably occur.

Alternatively, some systems permit protocols to be loaded at runtime, but the execution of the protocol is managed externally to the interacting parties, e.g., by a single intermediary that manages the interaction by controlling both sides of it.

In addition, prior work on business-to-business interactions and on software agents does provide support for generic, peer-to-peer interaction session and context. The context of the interaction, especially as it relates to constraints on message format and sequencing, is either treated as outside the scope of the interaction, or is held implicit in a rigid protocol. If expressed at all, it is not expressed in a computer readable form. For example, information on sequencing constraints is often found only in prose descriptions intended for application developers.

Thus, it would be beneficial to have an apparatus and method that avoids the limitations of the prior art with regard to the rigidity introduced by the use of a common protocol by providing flexible policies used by agents that are private to those agents. It would further be beneficial to have an apparatus and method that allows for similar, but differing, policies to be used by agents during interactions. Moreover, it would be beneficial to have an apparatus and method that allows for static and dynamic modification of these policies. In addition, it would be beneficial to have an apparatus and method that allows for modular implementation of these policies such that they may be retrieved and “plugged-into” existing conversation support mechanisms.

### SUMMARY OF THE INVENTION

The present invention provides an apparatus and method for providing modular conversation policies to agents. The present invention provides a mechanism by which conversation policies are implemented in a modular manner such that modification and personalization of the conversation policies to a particular application in an electronic business system is possible.

With the present invention, the conversation policies are implemented as objects that may be downloadable and pluggable into existing electronic business systems. Thus, the present invention allows conversation policies to be obtained from third parties and easily integrated into an established electronic business system.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in accordance with the present invention;

FIG. 2 is an exemplary block diagram of a server apparatus according to the present invention;

FIG. 3 is an exemplary block diagram of the primary modules in an electronic business system according to the present invention;

FIG. 4 is an exemplary diagram of a simple conversation policy (CP);

FIG. 5 is an exemplary block diagram illustrating the primary components of a conversation policy;

FIG. 6 is an exemplary block diagram illustrating the nestability of the conversation policies of the present invention;

FIG. 7 is an exemplary diagram of a state machine for a simple meta CP that invokes another CP;

FIG. 8 is an exemplary diagram of a state machine for the RFQ CP of FIG. 6;

FIG. 9 is an example of the “Suggest Revision” child CP state machine;

FIG. 10 is an example of the “Revise Order” child CP state machine;

FIG. 11 is an example of the “Haggle” child CP state machine;

FIG. 12 is an exemplary diagram of an exemplary computing platform for implementing conversation policies in an electronic business system;

FIG. 13 is an exemplary diagram of a process adapter according to the present invention;

FIG. 14 is a diagram illustrating an exemplary operation for processing an incoming message using CPs in accordance with the present invention;

FIG. 15 is an exemplary diagram illustrating how a conversation may be initiated between two electronic business systems (firms) using modular conversation policies in accordance with the present invention;

FIG. 16 is an exemplary diagram of a fine-grain state machine in accordance with the present invention;

FIG. 17 is an exemplary diagram of the state machine of FIG. 16 represented as a fine-grain state machine in which exit conditions are utilized;

FIG. 18 is a flowchart outlining an exemplary operation of the present invention when starting and executing a conversation using conversation policies; and

FIG. 19 is a flowchart outlining an exemplary operation of the present invention when downloading and automatically installing a conversation policy into a conversation policy module.

### DETAILED DESCRIPTION OF THE PREFERRED EMBODIMENT

The present invention provides a mechanism for providing modular conversation policies for agents. The present invention is preferably implemented in a distributed data processing system in which computing devices communicate with one another over one or more networks. In a preferred embodiment, the present invention is applied to communications and transactions between electronic business systems. Accordingly, a description of the distributed data processing environment will be provided in order to provide a context in which the present invention is implemented.

I. The Distributed Data Processing Environment

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN).

FIG. 1 is intended as an example, and not as an architectural limitation for the present invention.

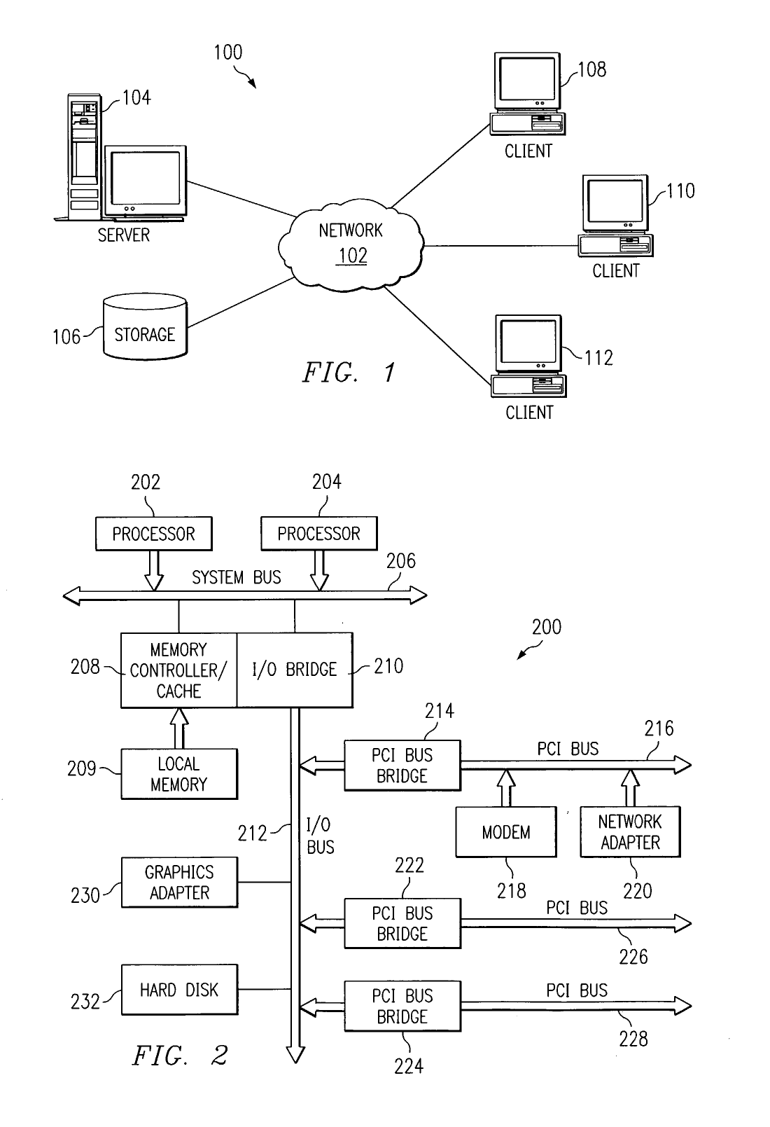

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

As mentioned previously, the present invention provides a mechanism by which conversation policies are implemented in a modular manner such that modification and personalization of the conversation policies to a particular application in an electronic business system is possible. With the present invention, the conversation policies are implemented as objects that may be downloadable and pluggable into existing electronic business systems. Thus, the present invention allows conversation policies to be obtained from third parties and easily integrated into an established electronic business system.

II. The Conversational Model

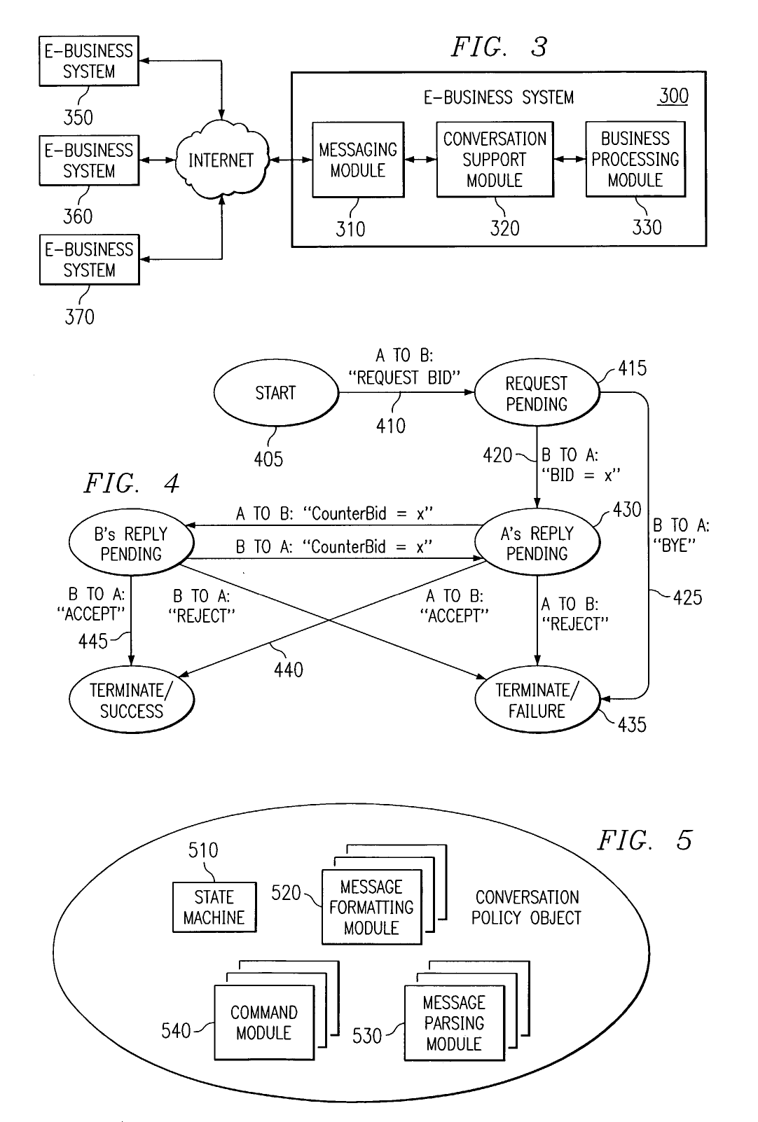

FIG. 3 is an exemplary block diagram of the primary modules in an electronic business system according to the present invention. As shown in FIG. 3, an electronic business system 300 may conduct transactions with a number of different electronic business systems 350-370 over a network, e.g., the Internet. The electronic business system 300 adopts a conversational model for electronic business interactions, in which an electronic business system interacts with others outside the firm by exchanging messages in “conversations.”

The electronic business system's functioning is separated into two broad categories: interoperability technology and business processes. As used here, “business process” is a broad term that encompasses whatever functions that are performed inside an operating firm, such as decision-making, execution of orders, etc., regardless of how or by whom the functions are performed. The interoperability technology, considered as a separate part, is the functions that an electronic business performs in order to communicate and interact with other entities, such as other electronic businesses.

In the conversational model, the interoperability technology consists of two distinct parts: a messaging module 310 and a conversation support module 320. The messaging module 310 performs the “nuts and bolts” functions needed to send and receive electronic communications with outside entities. The conversation support module 320 governs the formatting of messages that are to be sent, the parsing of messages that have been received, and the sequencing constraints on exchanges of multiple, correlated messages. The conversation support module 320 is a separate module that mediates between the messaging module 310 and the business processes module 330.

The business processes module 330 handles the business functions that govern the business decision making and business functions performed by the electronic business system 300. The business processes module 330 essentially executes the business logic which governs how the electronic business system 300 interacts with other entities from a business stand point, e.g., how to negotiate with other entities, when to accept or reject offers, etc.

This architecture provides a number of desirable features including:

A. Interaction Via Message Exchange

Message exchange is not the only means by which businesses might interoperate. For example, a business could interact with its suppliers and customers using any of a number of distributed programming models, distributed-objects standards, or service invocation models.

Message exchange has one advantage over all these alternatives: it correctly describes the firm's control boundaries. For example, if a firm exposes its Request for Quote (RFQ) processing functionality as a service to be invoked by its customers, it implies that the customer is the one who causes the RFQ to be processed. In actuality, of course, the firm inserts some sort of control point into the code that gets invoked, whereby the firm makes the decision of whether to really process the RFQ by calculating a quote and sending it back, or whether to refuse the customer's request. This control point changes the entire meaning of the interaction. It means that what the customer actually does is submit an RFQ with an implicit request that it be processed, i.e. the customer sends a message. The existence of the control point converts the “service invocation” into a “message delivery.” Adopting a message-exchange model from the outset makes the real nature of electronic business interactions explicit.

B. Conversation-Centric Interactions

At least as important as the adoption of message exchange is the adoption of “conversation-centric” interactions as opposed to “message-centric” interactions. This means that messages are sent within a conversational context. Conversations have an explicit beginning, middle, and end. Messages are automatically treated as belonging to the same overall context defined by the conversation itself. Adopting conversation-centric interaction amounts to recognizing that in the real world of electronic commerce, interactions typically consist of multiple correlated messages.

C. Message Delivery Independent of Content

This means that arbitrary message content may be exchanged by two parties in a conversation, even in cases where the recipient of a message is unable to recognize its meaning, make decisions about it, or even, perhaps, parse it. There are two fundamental reasons for this:

1. Proper assignment of function. Constraining the set of messages that may be sent or received is like programming your telephone to send or receive only words spoken in English (if such a thing were practical), i.e. it is a basic misplacement of function. The proper “job” of the messaging infrastructure, i.e. the messaging module 310, is to deliver messages, not to act as a supervisor defining what may and may not be said in a message. The job of defining what may and may not be included in a message is properly assigned to the conversation support module 320, as discussed in greater detail hereafter.

2. In fact, “unexpected” messages may turn out to be valuable, because they may contain clues as to how they should be handled. For example, if a person answers the phone and hears a voice that sounds like it might be speaking in French, the person might try to find someone nearby who could serve as interpreter; or, failing that, the person could reply in English and hope the other party will start speaking their language. In either case, it would be preferable to attempt the conversation with the other party than having a phone that refused to receive non-English messages. Thus, the combination of conversation-centric interaction with content-independent message delivery is an extremely powerful tool.

D. Conversation Management Independent of Message Delivery

As mentioned above, the messaging module 310 encapsulates the sending and receiving of messages, making it possible to support multiple transport mechanisms (e.g., XML over SOAP, JMS, etc.) by simply plugging them in.

E. Isolation of Interoperability from Business Process

Finally, the main reason that interoperability technology is held separate from the business processes is that in this way, the interoperability technology does not place constraints on how the core of the business works. The business processes performed by the business processes module 330 are what the interoperability technology supports, not prescribes. The business processes are the defining aspects of a firm that differentiates one firm from another. They are the processes that are most crucial to success and survival of the firm and not the something a firm would like to expose to the world. Interoperability allows the business process to be connected to the electronic business economy without turning the business processes over to someone else.

Controlling the business processes is the core of what it means to be an independent business engaged in trade. Each party in a trade, by definition, makes decisions unilaterally and executes them under its own control. Even when under contract, a firm's “sovereignty” is not compromised, because its decision to obey the contract is unilateral (as, of course, was its decision to sign the contract in the first place). To the extent that “interoperability” comes to encompass a firm's decision-making and/or execution processes, that firm is not engaging in trade, it is obeying directives.

In addition to the above advantages, the separation of interoperability from business processes allows for modification of the business processes on a different timetable from modification of the underlying messaging infrastructure and conversation support. Business processes change on different time scales from interoperability technology. Changing a business process needs to be done at a firm's instigation, on the firm's own time scale. By separating out the business processes from the interoperability, the changes to the business processes is not dependent on its customers, suppliers, and trading partners. Changes in interoperability technology are, by definition, on a “shared” time scale.

Moreover, the separation of business processes from interoperability lends itself to ease of modification. As discussed in more detail below, changes in interoperability can be accomplished by simply downloading an conversation policy object, an XML document, or the like. Therefore, changes in business processes are neither forced by changes in interoperability technology, nor hindered by it.

Though interoperability technology and business processes are clearly linked, just as clearly they are separate endeavors with separate driving forces, requirements and timetables.

In machine-to-machine conversations, i.e. electronic business system to electronic business system conversations, freeform dialogs are not practical. Therefore, electronic business interactions according to the present invention make use of preprogrammed patterns called conversation policies (CPs). Conversation policies are the underlying building block of conversation support.

A conversation policy is a machine-readable specification of a pattern of message exchange in a conversation. CPs consist of message schema, timing, and sequencing information. Message schemas describe the formats of the messages that may be exchanged. Sequencing and timing information is conveniently, though not necessarily, described by a state machine.

III. Overview of Conversation Policy

In the FIG. 4, an exemplary diagram of a simple conversation policy (CP) 400 is depicted. In the CP shown in FIG. 4, two participants, A and B, trade bids & counter-bids until one or the other of them accepts the current bid or gives up. Nodes in the graph correspond to different states of the conversational protocol. In effect, each node represents a summary of what has transpired so far in the conversation.

Edges connecting nodes represent transitions from one state to another. Each transition corresponds to a message being sent by one or the other party, and specifies the format or schema of the message as well as which party is the sender. For example, in the starting state 405 (labeled “Start”) there is one transition 410, labeled “A to B: Request Bid”, which corresponds to A sending a message to B of the form “Request bid.” The CP does not define any other way for the conversation to proceed from its starting state. Similarly, there are two transitions out of the state 415 labeled “Request Pending,” one in which party B sends a message 420 to party A of the form “Bid=x” (where x represents some value determined by B), and another 425 in which party B sends a “Bye” message.

In carrying on a conversation, each of the parties separately maintains its own internal record of the conversation's “current state,” and uses the CP to update that state whenever it sends or receives a message. For example, at the beginning of a conversation that follows the CP 400 in FIG. 4, A is in the “Start” state 405 of the CP. If and when it sends a “Request Bid” message 410 to B, it changes its current state to the “Request Pending” state 415. Similarly, B is initially in the “Start” state 405. If and when B receives a “Request bid” message 410 from A, B moves to the “Request pending” state 415. If B then sends “Bid=x” 420, it updates its current state to “A's reply pending” 430. Or, alternatively, if B sends a “Bye” message 425, it updates its current state to “Terminate/Failure” 435. When A, currently in the “Request pending” state 415, receives a message from B, it checks to see whether the message is “Bid=x” 420 or “Bye” 425, and then updates its own current state accordingly and so forth.

Thus, from the point of view of either party, this CP has two types of transitions: transitions that are taken when a message of a particular format is received, and transitions that are taken in order to send a message of a particular format. The sender of a message usually (though not always) has to make a decision as to which of the possible alternative messages to send, and often supply data as well, e.g., the value to fill in for the bid's amount, i.e. “X.” Similarly, the recipient usually must classify the message by identifying which of the possible alternatives was sent, and often must parse the message to unpack the data supplied by the sender.

As written, the CP is independent of the “point of view” of the company, i.e., which role, A or B, a given company is playing in a given conversation. The CP can just as easily be described within one role. For example, if role A is adopted, then transitions labeled “A to B” are interpreted as “send message”; and “B to A” are interpreted as “receive message.”

CPs enable extensive reuse of messages. Because a message is interpreted with respect to the conversation's current state, the same message can be safely reused in multiple contexts. For example, the message “OK” can be used in a bid/counterbid CP to signify acceptance 440, 445 of a bid, in an Request for Quote (RFQ) CP to signify acceptance of a quote, and so forth. In all cases, the contextual information supplied by the CP and the conversation's current state removes any ambiguity with regard to the reused message.

CPs also provide for economy of expression. With the use of CPs, there is no need to make messages self-describing “kitchen sinks” containing all possible context that might ever be used.

Because each of the conversing parties maintains its own record of the conversation's state, and uses its own CPs to update that record, the parties need not, in fact, be using exactly the same CP. The minimal requirement is that, in the course of a particular conversation, the sequence of messages they exchange corresponds, on each side, to some path through the particular CP that party is using. Thus, the use of CPs in accordance with the present invention allows for private conversation policies for the agents involved in a transaction as long as those private conversation policies are capable of exchanging a corresponding sequence of messages.

Conversation policies (CPs) may optionally specify timing constraints as well. In a preferred embodiment, timing constraints are specified by defining “timeout” transitions, such that, after a given time interval has elapsed during which no message has been received (or sent), a transition to another state is taken. This simple mechanism is sufficient to enforce both minimum and maximum time limits on remaining in a state.

Timeouts can also be specified for the execution of sequences of messages. For example, when used with nested CPs (described below) this can place timing constraints on the execution of sequences of entire CPs.

IV. Composition of a Conversation Policy

FIG. 5 is an exemplary block diagram illustrating the primary components of a conversation policy. As shown in FIG. 5, each CP consists of a state machine 510, a set of message formatting modules 520, a set of parsing modules 530, and a set of “command” modules 540. Depending on the particular CP that is constructed, one or both of the formatting modules 520 and parsing modules 530 may be present in the CP.

The state machine 510 governs the types of messages and sequence of messages that may be sent or received by the electronic business system utilizing the CP. The state machine 510 is further used to maintain information about the present state of the conversation involving the electronic business system. Based on the current state, the CP may determine from the state machine 510 which messages may be sent or received and thus, to which next state the conversation will proceed.

Formatting modules 520 are used to convert data, such as part numbers, quantities, prices, etc., for sending. Parsing modules 530 do the inverse operation, i.e. they unpack a message that has been received. Command modules 540 are calls to the business processes, used when a decision needs to be made and when data must be supplied for formatting an outgoing message.

The command modules 540 provide the link between the conversation policy and the business processes module 330 of FIG. 3. The formatting modules 520 and parsing modules 530 provide a link to the messaging module 310 of FIG. 3. The state machine 510 is the primary element for implementing the functionality of the conversation policy with regard to governing the messages sent and parsed by the electronic business system.

In a preferred embodiment, the elements 510-540 are encapsulated into an instance of a conversation policy class. Thus, the elements 510-540 are packaged into a CP object that may be provided in a modular manner to electronic business systems. In order for an electronic business system to implement a new CP, the electronic business need only download the CP object from a third party vendor, or otherwise install the CP object into the electronic business system. In particular, the CP object is provided to the conversation support module 320 of FIG. 3 which may then utilize the CP object by invoking it.

V. Nesting of Conversation Policies

In day-to-day business, a firm's interactions with other firms tend to be made up of common, conventional interaction patterns. That is to say, its conversations tend to have phases or “stanzas” which fall into common patterns, and are reused in different contexts. For example, first there might be a discussion of product discovery, then negotiation of the deal, finally settlement. Thus, the conversation is a nested one in which multiple messages are exchanged and functions performed that make up each “stanza.”

For example, product discovery might start with the customer expressing needs, the seller asking pointed questions about them and then recommending a list of possible matches, followed by the buyer making a selection from the list. Negotiation might start with a discussion of the way to negotiate, e.g., haggle over price, place bids in an auction, etc., followed by a pattern of message exchange appropriate to that negotiation method. After the products are dealt with, then the parties might turn to a dialog about delivery options and prices. Similar, settlement might start with an inquiry into the methods of payment supported, followed by a selection of one of them.

Conversation policies according to the present invention provide for such nesting of functionality. As part of carrying on of a conversation that obeys a given CP, the conversing parties might choose to start a new CP as a “sub-conversation,” possibly carry it out to completion, then return to the previous CP. In effect, both parties carry on a more narrowly-scoped “child” conversation within the enclosing context of the more broadly-scoped “parent” conversation.

FIG. 6 is an exemplary block diagram illustrating the nestability of the conversation policies of the present invention. As shown in FIG. 6, a “meta” conversation policy 610 is provided that is the overall governing CP that controls the messaging in the conversation for the particular electronic business system implementing the “meta” CP 610. The “meta” CP 610 basically is used to invoke other CPs, although it is not necessarily limited to invoking other CPs. Rather, the meta CP 610 may include other states and transitions that do not necessarily require the invoking of other CPs without departing from the spirit and scope of the present invention.

The meta CP 610, in a preferred embodiment, includes transitions to other “child” CPs including the Request for Quote (RFQ) CP 620. The RFQ CP 620 further includes transitions to its own child CPs that include the Suggest Revision CP 630, the Revise Order CP 640, and the Haggle CP 650. Thus, a nested hierarchy of CPs is provided such that transitions are provided in parent CPs for instigating child conversations of a parent conversation using child CPs.

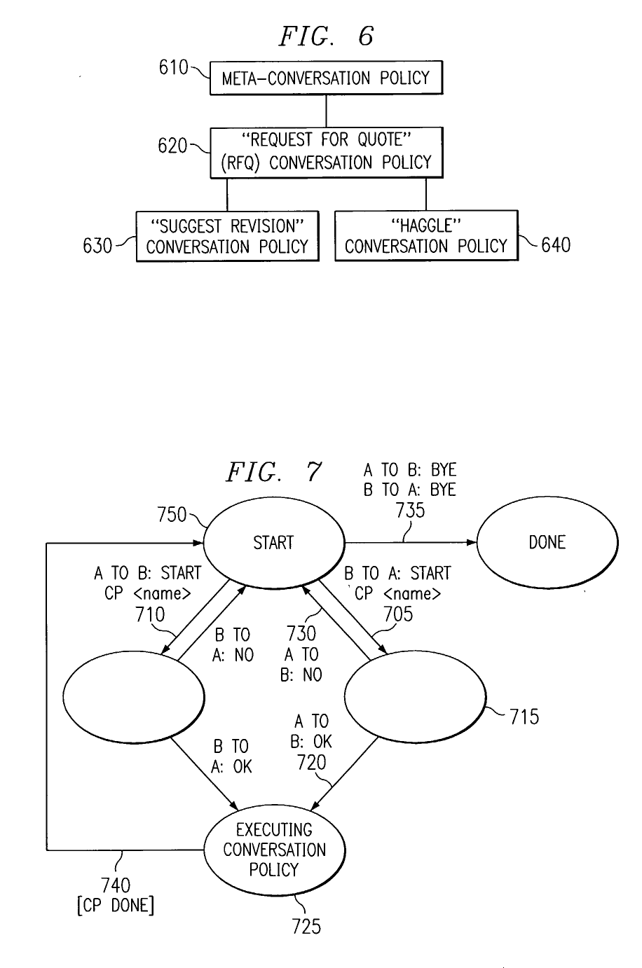

To further illustrate the nestability of CPs, FIG. 7 is an exemplary diagram of a state machine 700 for a simple meta CP that invokes another CP. A shown in FIG. 7, the meta CP either transmits or receives a message requesting the start of a CP with the name <name>. For the agent playing role A, receiving this message corresponds to taking transition 705, and transmitting it corresponds to taking transition 710; for the agent playing role B, transmitting it corresponds to 705 and receiving it corresponds to 710. If agent A receives a request message it moves to state 715. If the CP named in that message is recognized by agent A, and that agent decides to execute a conversation that follows that named CP, then agent A will take transition 720 in the meta CP, causing the meta CP to send the message “OK”, and will move to state 725, causing the meta CP to begin executing the named CP. If, however, the agent does not recognize the name of the requested CP, or for some other reason chooses not to carry out that conversation, the meta CP will return a “NO” message 730 and return to the start state 750, in which it may send a “Bye” message 735, may send a another request to start a CP (possibly with a different name), or may receive similar messages from agent B. From state 725, when the named CP is done executing, the meta CP takes transition 740 back to the start state 750. Similar functionality is performed when the meta CP shown in FIG. 7 is the instigator of the conversation (see “A to B” messages on left side of the figure).

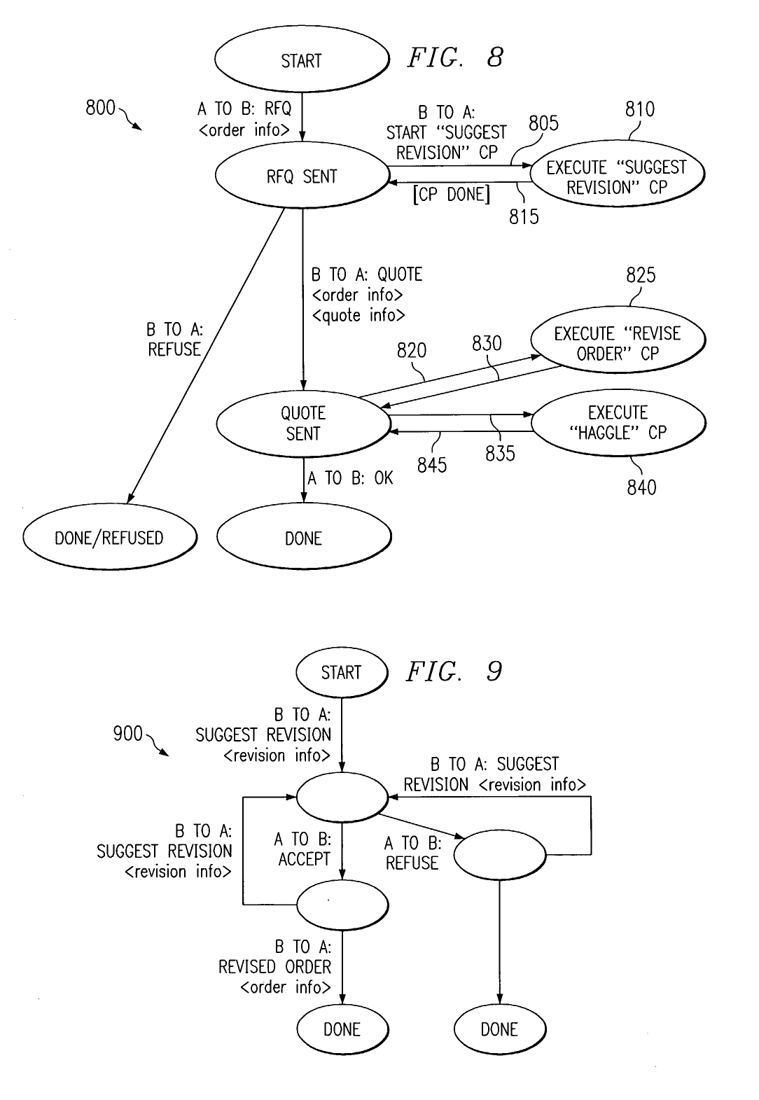

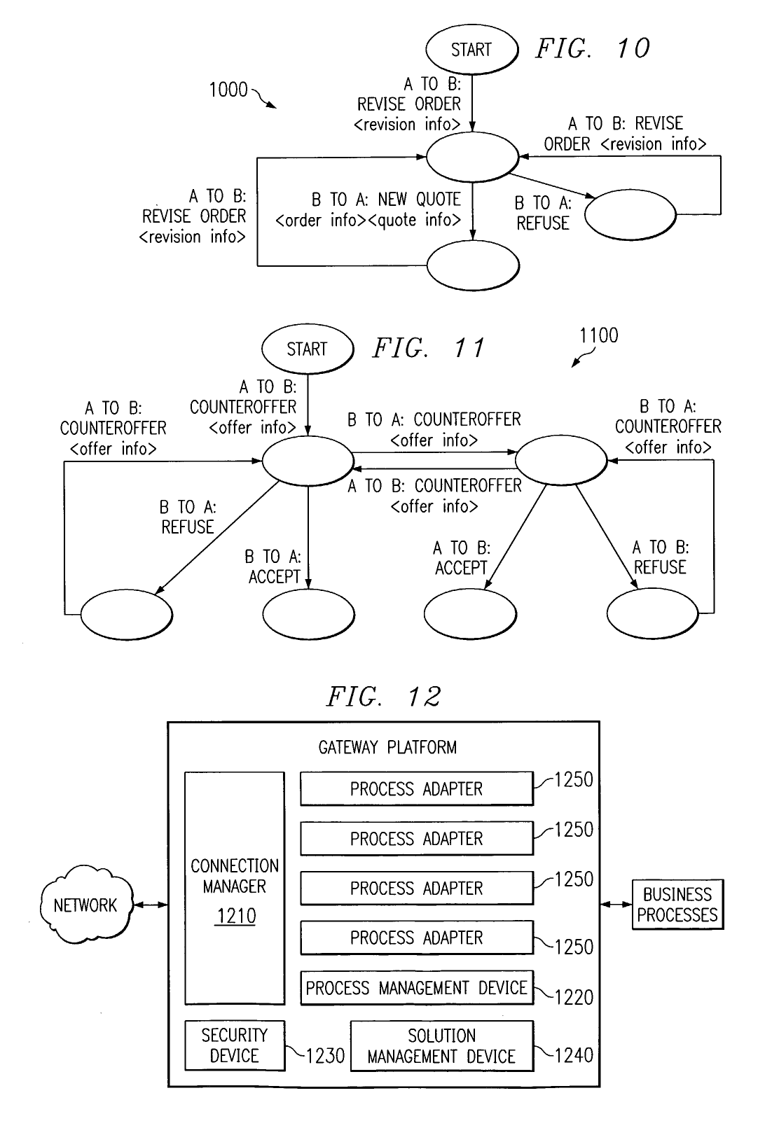

FIG. 8 is an exemplary diagram of a state machine 800 for the RFQ CP 620 of FIG. 6. The RFQ CP of FIG. 8 may be instigated as part of the “executing conversation policy” state 725 in FIG. 7. As shown in FIG. 8, the state machine comprises a number of states and transitions that include states for executing child CPs. In the particular example shown, the RFQ CP includes states and transitions for executing the “Suggest Revision” child CP, 805, 810 and 815, respectively; the “Revise Order” child CP, 820, 825 and 830, respectively; and the “Haggle” child CP, 835, 840 and 845, respectively. An example of the “Suggest Revision” child CP state machine 900 is provided in FIG. 9. An example of the “Revise Order” child CP state machine 1000 is provided in FIG. 10. An example of the “Haggle” child CP state machine 1100 is provided in FIG. 11.

The “meta” CP example discussed above with respect to FIGS. 6 and 7 shows that parties might use a parent CP to negotiate over which child CP to start. This can be done even if the child CP is not known beforehand by the agent being asked to start it. For example, the interaction might unfold as follows:

1. In the parent CP, there is a transition in which one party sends a message containing the name of a child CP that it would like to start executing. This name may be supplied by the sender's back-end business logic, so that the parent CP would have a state “executing child CP” where the CP name is determined at runtime, not when the parent CP is written.

2. The recipient of this message, on receiving it, would look for a CP matching that name in its local repository of CPs. If it did not find the CP, it may initiate a separate conversation with a CP-vendor agent, in which it obtains (e.g., by purchase) the CP. Then the agent may attempt to “wire in” the newly-downloaded CP and begin executing it.

This “wiring in” may be done manually, may default to a generic default decision-making endpoint (such as a terminal for human input), or it may be done automatically. The latter option is possible under certain conditions—i.e. Automatic “wiring in” works when the agent already possesses the back-end business logic to make all the decisions required to execute the new CP, and when the agent has the ability to automatically connect the CP's decision points to that back-end logic.

One way this wiring in may be automated is if the CP-vendor provides, in addition to the CP itself, “wiring in” information specifically tailored to the agent's back-end logic. For example, the CP-vendor may also have provided or configured the agent's back-end logic system, in such a way that the functionality of the back-end logic system, and the means of accessing it, is known to the CP-vendor. Another alternative is for the CP-vendor to provide “wiring in” information in terms of a standardized way of accessing functionality, such as by means of intra-enterprise Web Services obeying a public naming convention. In that case, the agent buying the CP would need to support the Web Services required to connect the newly-downloaded CP to its back-end system.

This “wiring in” information is also referred to a binding information. The binding information binds the states and state transitions identified in the CP to business processes of the back-end logic. The binding information essentially specifies the business processes to execute at the decision points in the state machine, i.e. the states in which the computing device may make a decision as to which state transition to take. For example, in the CP 400 shown in FIG. 4, the state 430 labeled “A's reply pending” is a decision point for the computing device playing the role of “A”. The business process bound to that state would determine which of the three possible transitions the computing device should take (send counteroffer, accept, or reject) and if necessary supply any additional data required to make the transition (such as the detailed content of a counteroffer message to be sent). For each role defined in a CP, binding information may be supplied to permit the computing device to play that role.

A vendor of the business processes of the back-end logic may make such binding information available for new CPs as updates to the back-end logic, for example. Alternatively, a vendor of the CP or some other third party entity may make such binding information available. During the automatic wiring in process described above, this binding information may already be present on the computing system or may be downloaded at approximately a same time as the CP is downloaded from the same or a different source. By providing this binding information a newly downloaded CP may be simply plugged into the conversation support module of the electronic business system and be able to be used automatically without the need for human intervention.

Thus, through the modular implementation of conversation policies, nesting of conversation policies is made possible. This allows for added expandability and changeability of conversation policies. A conversation policy may be expanded by simply adding a new state and transition to the state machine of a conversation policy that invokes another conversation policy. Furthermore, changes to the conversation policy may be made by modifying only the child conversation policy. Moreover, reuse of child conversation policies is made possible.

In an alternative representation, a conversation policy need not consist of a single connected graph of states and transitions. For example, if there are multiple sub-conversations to be carried out, but there are no constraints on the sequence in which the sub-conversations are executed, then the sub-conversations may be conveniently represented as isolated state-machines. The conversation policy as a whole may consist of the union of the state-machines for the sub-conversations, all of which are considered simultaneously active. In this case, it is necessary for the conversation-management software to correctly identify which sub-conversation a given message applies to. This is straightforward if no two sub-conversations have any messages in common.

Another alternative representation uses pre- and post-condition tests to determine when to make transitions between states, such that exchanges of multiple messages may take place while the conversation is in a single state. In this representation, the CP remains in a single state throughout an entire “phase” of a conversation, until certain specified exit conditions are reached. For example, a CP for carrying out complex negotiations may contain a single state for “negotiation in progress”, and remain in that state regardless of what messages are exchanged, until a certain predefined exit-condition is met. Examples of exit conditions include, but are not limited to, the following: the exchange of specific messages, such as messages confirming that an agreement has been reached; a signal from the back-end business logic that the conversation should move to another state; or the determination of values for a predefined set of attributes, such as price, quantity, color, etc., of a product.

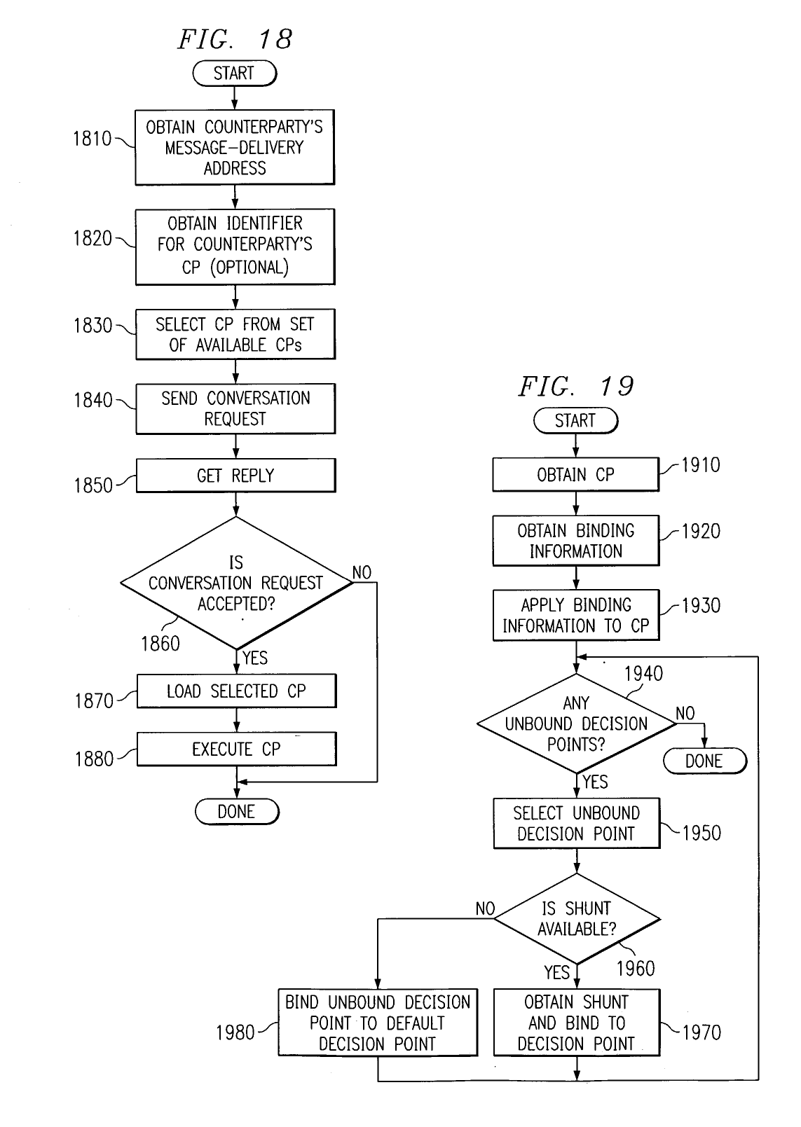

An isomorphism exists between the fine-grained state-transition CPs (as exemplified by FIG. 4) and states with transitions governed by exit conditions. For example, consider the fine-grained state machine 1600 shown in FIG. 16. A loop 1605 exists between states S1 1610 and S2 1615, permitting the two agents to exchange an arbitrary number of propose/counteroffer messages 1620, 1625 concerning the attribute X. This same protocol can be expressed using an exit condition, as shown in FIG. 17, in which the loop is represented as a single state LX 1705 with an exit condition 1710 that A and B both agree to a value for X. This example differs from a CP in which the propose/counteroffer loop is executed within a child-CP, in that no child CP is loaded or executed.

In a more complex example, the two agents may negotiate over several attributes (X, Y, and Z) which may be mutually related. A fine-grained CP for this might go through a series of states which permit each agent to change the value of X, Y, and Z, until both agents exit through an exchange of “Agree values”, “Accept values” messages. However, if the attributes are correlated, then holding separate negotiations over each attribute is undesirable. In this case, a find-grained CP may be written with separate states for “X agreed on, but Y and Z not”, “X and Y agreed on, but Z not”, and so forth.

Alternatively, a CP that uses exit conditions would show a transition for entering a negotiation, with an exit condition that is met when both agents have agreed to all three values. This would permit agents to exchange messages making proposals for one, two, or all three of the values, without requiring explicit states for all the different possibilities of partial agreement.

VI. Exemplary Platform for Implementing Conversation Policies

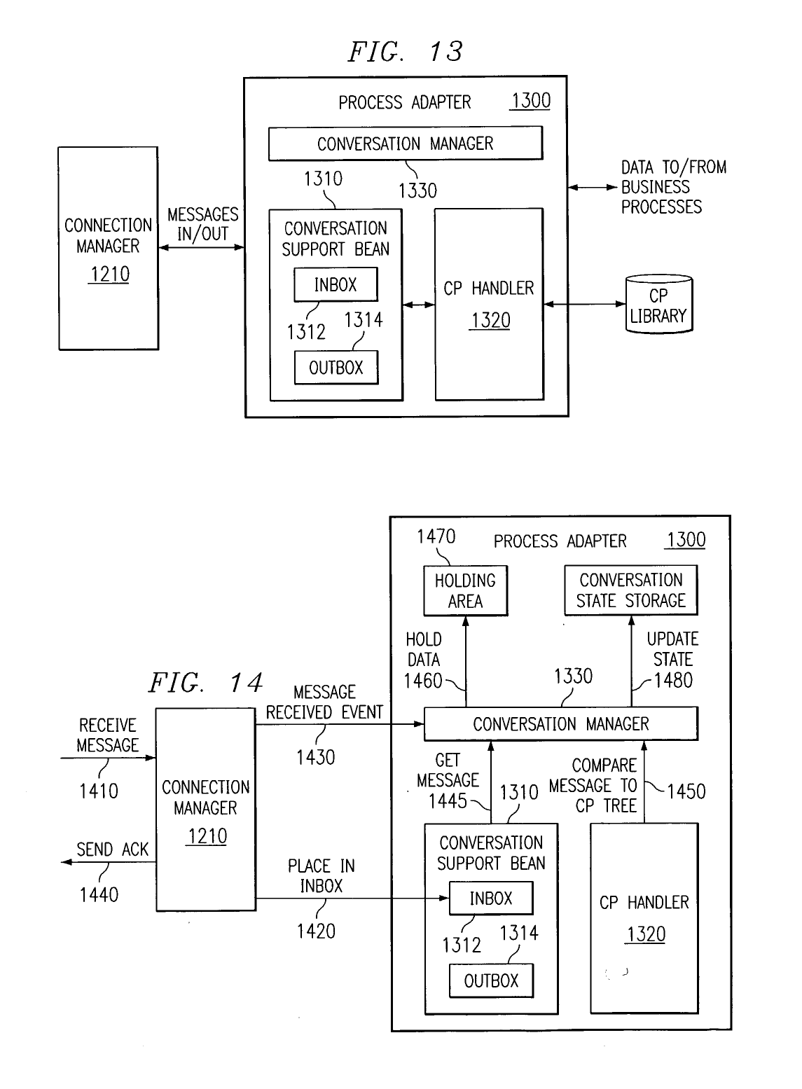

FIG. 12 is an exemplary diagram of an exemplary computing platform 1200 for implementing conversation policies in an electronic business system. It should be appreciated that the platform illustrated in FIG. 12 is only intended for illustration purposes and is not intended to imply any requirements or limitations on the computing systems that may make use of conversation policies in accordance with the present invention.

As shown in FIG. 12, the exemplary computing platform 1200 encapsulates the interoperability technology of the present invention into a gateway unit 1205 capable of operating on its own, or in conjunction with a business process broker. The present invention, however, is not limited to use as a gateway. For example, the present invention may be integrated directly into an electronic business system 1206 of a firm or distributed over a plurality of devices in a network 1208 of computing devices.

As shown in FIG. 12, the platform includes a connection manager 1210, a process management device 1220, a security device 1230, a solution management device 1240, and one or more process adapters 1250. The connection manager 1210 provides the messaging functionality and is akin to the messaging module 310 described in FIG. 3. The process adapters 1250 provide the conversation support of the present invention in the form of conversation policies. The other elements 1220, 1230 and 1240 provide other functionality that will be readily understood by those of ordinary skill in the art, including maintaining security, managing the business processes, and the like, which may be included in the processing of messages to and from an electronic business system but are not essential to the description of the present invention and thus, are not described in further detail herein.

The connection manager 1210 supports and encapsulates a variety of messaging protocols, such as SOAP, RMI, HTTP, and the like. The connection manager 1210 is designed so that additional protocols may be added as pluggable modules. The connection manager 1210 supports asymmetric messaging within a conversation, i.e., outbound messages in the conversation sent via one protocol, inbound received via another.

An exemplary diagram of a process adapter is shown in FIG. 13. The process adapter 1300 contains a conversation support bean (CSB) 1310, a conversation policy handler (CPH) 1320, and a conversation manager 1330. The CPH 1320 holds a tree of CP instances, i.e. parent CPs and their child CPs organized into a tree hierarchy. The process adapter 1300 passes outbound messages to the connection manager 1210 for delivery, and receives inbound message from the connection manager 1210 for processing. On the other side, the process adapter 1300 sends data to, and receives data from, the business processes.

Each process adapter 1300 supports a single conversation. Multiple simultaneous conversations are handled by separate process adapter instances. When a conversation is first set up, a new conversation manager 330, CSB 1310 and CPH 1320 are created, for the purpose of managing that conversation. Typically a CP instance is created as well, and installed as the root of the CPH's tree. Then, as the conversation proceeds, other new CP instances are created and installed in the CPH's tree, as needed. Finally, when the conversation ends, all of these structures are torn down (or pooled for reuse in another conversation).

The conversation support bean (CSB) 1310 takes care of maintaining the conversational context. The CSB consists mainly of an “inbox” 1312 into which all incoming messages in the conversation are placed, in order of arrival, and an “outbox” 1314 in which outgoing messages are placed, for delivery by the connection manager 1210. In a conversation, the outbox 1314 of one party is in effect connected to the inbox 1312 of the other.

CSBs 1310 are created during a conversation setup phase, in which the two parties exchange inbox 1312 identifiers. Then, in each subsequent message, the sender uses the recipient's inbox identifier to direct the message to that inbox.

In a preferred embodiment, the connection manager 1210 is the common Internet endpoint for all messages in all conversations that a firm engages in. In order to direct a message to a particular conversation, the sender's connection manager 1210 inserts the recipient's conversation-specific inbox 1312 identifier into the header of each outgoing message before delivering it. Then, upon delivery, the recipient's connection manager extracts that inbox identifier from the header and uses it to put the message in the inbox of the CSB set up for that particular conversation.

The conversation policy handler (CPH) 1320 maintains a set of CP instances in use during the conversation. CPs are arranged in a tree, which is managed by a CPH 1320. The job of the CPH 1320 is to manage the creation of new nodes in the CP tree and/or delete nodes in the CP tree when they are no longer needed. One CP in the tree is designated as the Active CP. This is the CP that is currently being used to carry on the conversation. When, during the course of conversing, it comes time to start a sub-conversation, the conversation manager 1330 creates a new CP instance of the appropriate type, installs it in the CPH 1320 as the child of the Active CP, and then makes the newly created CP the new Active CP. When that sub-conversation is over, the conversation manager 1330 removes it from the tree and makes its parent the Active CP once again.

Starting a sub-conversation is an example of leaving a conversation unfinished (i.e., the parent conversation is unfinished), carrying on another conversation for a while, and then returning to the unfinished conversation. It is also possible to leave sub-conversations unfinished, return to a higher contextual level (i.e., a higher node in the tree), and start a new CP from that node. This is why the CPH 1320 arranges its CP instances in a tree structure, rather than in a stack.

The CP tree provides a certain degree of graceful error handling. Built into the handling of messages is the default behavior that, if a message is received that does not conform to any of the messages allowed by the CP protocol at that point in the conversation, the message gets passed up to the parent CP, which is then reactivated. If, for example, a CP for processing RFQs receives a message it does not recognize, e.g., a query about the shipping information, its default behavior is to pass that message off to its parent. This reflects the fact that the parent CP, with its broader context, is more likely to recognize the message than the child CP. If the parent CP does not recognize it, it passes the message up to its parent CP, and so forth, all the way up to the root node of the CP tree.

If the root node of the CP tree does not recognize the message, error handling may be instigated for handling the receipt of the message. Such error handling may include dropping the message, returning an error message to the other entity involved in the conversation, requesting information regarding the message from the other entity, and the like. In one particular embodiment of the present invention, the root node of the CP tree may include a functionality for requesting the CP that allowed the message to be sent from the other entity. In this way, the entities may exchange CPs during a conversation to handle instances of messages that are not recognized by one or more of the parties involved in the conversation.

Other ways of handling unexpected messages can be built into individual CPs. For example, a CP may itself have a transition for “none of the above,” i.e. if any message other than the ones expected is received, take that transition. This is appropriate when the sequence of messages needs to be carefully constrained, such as in the middle of a payment, for example. Other more flexible and less flexible approaches may be devised without departing from the spirit and scope of the present invention.

VII. Processing of an Incoming Message Using CPs

Taking the above platform as an exemplary platform in which the present invention may be implemented, FIG. 14 is a diagram illustrating an exemplary operation for processing an incoming message 1410 using CPs in accordance with the present invention. Processing of an incoming message is as follows:

1. The connection manager 1210 places the message 1420 in the CSB's inbox 1312, raises a “message received” event 1430, and returns a delivery acknowledgment 1440 to the sender.

2. The conversation manager 1330 picks up 1445 the message and attempts to find a transition to take in the current active CP. It does this by searching 1450 for a transition from the CP's current state that corresponds to receiving that particular message. This involves executing a message parsing module associated with that transition, which compares, the format of the message against an expected schema, and, if the format is correct, unpacks the data in the message and places 1460 it in a holding area 1470.

3. If such a transition is found, the conversation manager updates 1480 the CP's current state (to the destination state of the transition) and executes any other actions associated with that transition. This will often involve passing the message's data on to the business processes.

Often, as a result of an event such as the receipt of a message, the CP moves to a state from which there are transitions for sending messages. This is a decision point in the CP, in the sense that information from the business processes is required in order to select which transition to take, and/or to specify the data to be packed into an outgoing message. These transitions are taken at the instigation of the business processes. That is, the CP itself does not “call” the business process for a decision, or for data. Rather, the business process raises an event on the CP, which specifies which transition it should take, and supplies the data it should use. In this way, the business processes are always in charge of all outgoing messages.

VIII. Initiating a Conversation Using Cps

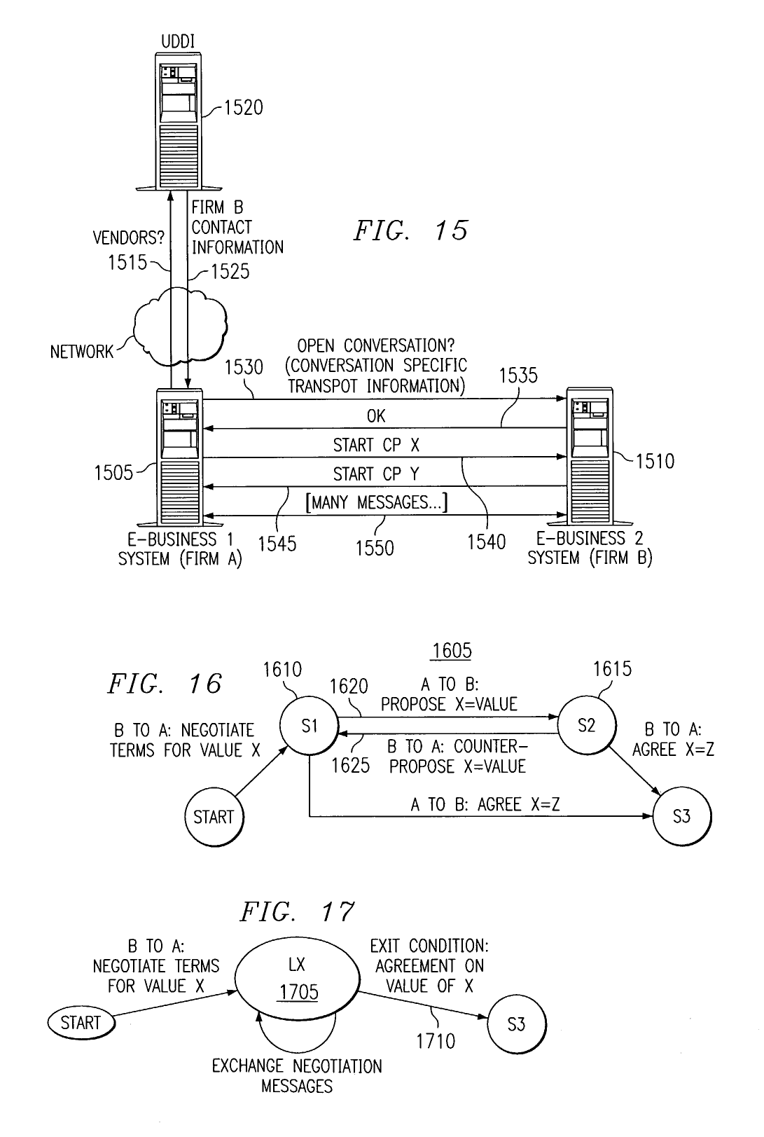

FIG. 15 is an exemplary diagram illustrating how a conversation may be initiated between two electronic business systems (firms) 1505, 1510 using modular conversation policies in accordance with the present invention. In the example shown in FIG. 15, it is assumed that both firms 1505, 1510 are running some form of conversation support and that Firm A 1505 wants to start a conversation with Firm B 1510, which it knows by name only.

Step 1. Firm A 1505 issues a Universal Description Discovery and Integration (UDDI) request 1515 for the contact information 1525 of Firm B 1510 or, alternatively, Firm A 1505 looks up the contact information in its own address book. The UDDI service 1520 provides descriptions of electronic businesses and their web services. The UDDI schema includes four types of service information: business information (e.g., name and contact information), business service information (e.g., general descriptions of web services), binding information (e.g., how to invoke a service), and service specification information which associates the service's binding information with the business service information it implements.

The contact information specifies the messaging protocol, URL, etc., that Firm B 1510 prefers others to use for initial contact. For example, Firm B 1510 might use SOAP over HTTP, and list the URL of its SOAP RPC router, and the URN of the object it has deployed to receive messages via SOAP. Firm B's listing might possibly also include the name of the conversation policy B 1510 starts up by default at the beginning of a conversation, if indeed it does so.

It should be noted that the conversation policies that Firm B 1510 uses need not be the same as the conversation policies used by Firm A 1505. That is, because of the ability to pass up messages to parent CPs and provide for handling of unrecognizable messages using various techniques, a requirement that both firms have the same CP is not necessary with the present invention. In fact, so long as the transitions in the CPs somewhat correspond so that the CPs of the Firms A 1505 and B 1510 recognize the messages received, errors will not be introduced into the conversation.

Alternatively, the UDDI server 1520 may, as part of the contact information, include a listing of CPs that are compatible with the conversation policy that B uses at start up of a conversation. If Firm A uses a conversation policy that is compatible with the one used by Firm B, the conversation may be properly started. Thus, for example, if Firm B uses meta CP #3 and meta CP #3 is compatible with meta CP #302, then Firm A may open 1530 a conversation with Firm B using meta CP #302, as illustrated.

This same functionality for having differing conversation policies that, despite their differences, are compatible may be extended to any conversation policy implemented by either of Firms A or B. Thus, for example, if Firm A starts a conversation policy CP RFQ #4, Firm B may start a CP RFQ #340 which is compatible with CP RFQ #44.

Step 2. Firm A 1505 sends Firm B 1510 a request 1530 to open a conversation. In its request, it supplies the conversation-specific transport information that B will need in order to converse with A. This will include, in addition to the message-transport information (e.g., URL of RPC router, URN of deployed object), A's conversation-specific inbox identifier. Firm B returns 1535 an acceptance message (if it does accept, that is), which includes its own conversation-specific transport information, including its own conversation-specific inbox identifier. At this point, each firm sets up a process adapter for use in this conversation, each with its own CSB, CPH, and conversation manager.

Step 3. Firm A next starts 1540 its top-level CP, e.g., a “Meta” CP. It might send a message to Firm B that it has done so, giving the meta CP's name and version number. Firm B also starts up 1545 its own meta CP and may send a message to firm A identifying the meta CP name and version number.

Step 4. Firms A and B start exchanging 1550 messages.

As previously mentioned, the use of modular CPs according to the present invention allows for flexibility with regard to the conversation support aspects of an electronic business system. The following scenarios are intended to illustrate how the modular aspect of the present invention allows for such flexibility.

Consider a firm that purchases a gateway platform such as that described in FIG. 12. Assume that the firm orders a service package of conversation policies for a particular type of interaction with other firms. The service package is largely self-installing. Many of the decision-points in the CPs come pre-configured with “shunts” that automatically supply a safe default behavior. Company input is required only for connecting the CPs to its business processes 1206 at the remaining, un-shuntable decision points. Thus, using gateway tooling, the implementation of the gateway in the firm's business system, as far as the gateway end is concerned, is quick and easy.

The business process end will vary in its difficulty, since its difficulties are determined by the firm's particular business processes, which of course vary widely. If the firm is already using a process broker that is designed for this gateway platform, the implementation of the gateway is straightforward. It is equally straightforward if the firm wants to do its decision-making manually while it is working to increase its automation level. In such a case, the CPs may simply use a general-purpose connection to a human operator.

Assume also that later, the firm wants to add order tracking CPs. The firm then buys the “order tracking service package” that includes the CPs for performing order tracking. Again the service package is self-installing but the self-install is easier this time, because many of the CPs use “stanzas” that came with the previously purchased service pack. The firm can customize the behavior of these reused CPs as needed to fit the new context, but many of them do not need any customization.

In another scenario, Firm A has many trading partners that use a particular “RFQ” CP. Some are well-trusted, some known to be less than trustworthy. Firm A is also using RFQs with companies it knows little about either way. Firm A has an “old” RFQ CP that cannot Haggle. It has settled into a stable pattern with its various partners about which version of the “Suggest Revision” CP to use with each.

Firm A decides to upgrade to a newly released version of the RFQ CP, with Haggle. All the preparation work, i.e., implementing the strategic decision-making needed to haggle effectively, is done in private. The final step, installing the new CP, is completed within a few seconds after the haggling-strategy code is approved by management.

The new CP is also backwards compatible. With those trading partners that still use old version, Firm A's attempts to start a Haggle generate a “Sorry, message unknown” response. Firm A then abandons attempt to haggle & goes on with the rest of the transaction as it always has. On the other hand, with those trading partners that are already using the Haggle CP, A gets instant ability to haggle with them.

In yet another scenario, Firm B's monitors Firm A and notices that it keeps getting asked whether it wants to “Haggle.” Somebody at Firm B (maybe the monitoring software itself) decides to investigate. Firm B soon discovers that the “Haggle” CP has recently been added to the set of CPs its interoperability vendor supports. Firm B downloads the file giving the state machine and the formatting and parsing modules for any newly-defined messages used by the CP.

In many cases, it is possible to also get a “shunt” along with the new CP, which defines a default, “safe” behavior at the new CP's decision points. For example, in the Haggle CP, Firm B might download a shunt that automatically refuses any counteroffer lower than the price it originally quoted. In this way, Firm B can automatically upgrade its interoperability capabilities, and remain “live” as it gradually upgrades its decision-making business processes to take strategic advantage of those capabilities.

As a further scenario, Firm A has invested in a high-quality CP for gathering customer address and billing information. Now Firm A wants to use this CP in a completely new context, such as for online auctions.

This is where the nesting and composition of CPs is very beneficial. With the CP handler, this sort of rearrangement of sub-CPs is simple. It is merely a matter of configuring the “parent” CP to use the high-quality CP as its billing “stanza.”

In another scenario, Firm A has been using a set of CPs, which are connected to a particular set of business processes. Firm A now wants to upgrade or replace a part of that business process without making any noticeable change in its interoperability.

In this case, the firm has exactly one task to do: it must “re-wire” the connection between its CPs and its business processes. The existence of conversation support as a separate module helps this process tremendously. It also ensures that the firm's ability to interoperate will not be accidentally compromised.

FIG. 18 is a flowchart outlining an exemplary operation of the present invention when starting and executing a conversation using conversation policies. As shown in FIG. 18, the operation starts with obtaining a counterparty's message delivery address (block 1810). This may be done, for example, by sending a service request to a UDDI service provider that then provides a list of service providers that provide a requested service and selecting a service provider from the list of service providers.

Once the message delivery address is obtained, an identifier of the counterparty's conversation policy may be obtained (block 1820). This block is optional and may be eliminated without departing from the spirit and scope of the present invention. Either after block 1810 or after block 1820, a conversation policy to be used during the communication with the counterparty is selected (block 1830). The selection of the conversation policy to be used may be based on preferences established, for example, in a configuration file or the like. Such preferences may include, for example, a designation of a name of a conversation policy to be used in all conversations, a mapping of conversation policies to counterparty identifiers, information obtained during a previous conversation with the counterparty, and the like. The selection of the conversation policy may also be based on the identification of the counterparty's conversation policy.

A conversation request is then sent to the counterparty (block 1840) and a reply is received (block 1850). A determination is made as to whether the reply indicates that the counterparty accepted the conversation request (block 1860). If not, the operation terminates and the conversation is not conducted. If the counterparty accepted the conversation request, the selected conversation policy is loaded into the conversation policy module, e.g., the conversation support module or conversation policy handler (block 1870). The selected conversation policy is then executed (block 1880). Execution of the conversation policy may include spawning of child conversation policies, downloading of conversation policies and automatic installation of conversation policies, and the like, as previously described above.

FIG. 19 is a flowchart outlining an exemplary operation of the present invention when downloading and automatically installing a conversation policy into a conversation policy module. As shown in FIG. 19, the operation starts with obtaining the conversation policy (block 1910). This may be accomplished by downloading or otherwise receiving the conversation policy from a counterparty computing device or a third party computing device, for example. Binding information mapping the conversation policy's decision points to extant business processes is obtained (block 1920). As described previously, this may include obtaining this binding information as business process updates from a business process vendor, or may be obtained from the conversation policy vendor or another third party, for example.

The binding information is then applied to the conversation policy (block 1930) and a determination is made as to whether there are any unbound decision points (block 1940). If not, the operation ends and the conversation policy is now usable with the conversation policy module.

If there are unbound decision points, a decision point is selected (block 1950) and a determination is made as to whether a shunt is available for the decision point (block 1960). If a shunt is available, the shunt is obtained and bound to the decision point (block 1970). The operation then returns to block 1940. If a shunt is not available, a default decision point, e.g. notification sent to a human administrator, is bound to the unbound decision point (block 1980) and the operation returns to block 1940. Once all unbound decision points are bound to either a shut or default decision points, the operation terminates with the conversation policy now being available for use by the conversation policy module.

Thus, the present invention provides a mechanism for modular downloadable conversation policies that may be used to govern the interactions of computing devices during communications between the computing devices. The conversation policies are dynamically instantiable such that parent conversation policies may spawn child conversation policies. Moreover, conversation policies may be dynamically downloaded and installed into an electronic business system for use in a current or later initiated conversation with a computing device. In addition, the present invention allows for two computing devices to use dissimilar conversation policies during the same communication with one another so long as the states and state transitions identified in the state machine of the conversation policies are compatible.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of communicating between a first computing device and a second computing device, comprising:
selecting a first conversation policy from a set of conversation policies based on one or more criteria;
loading the first conversation policy into a conversation policy module; and
communicating with the second computing device using the conversation policy module, wherein the conversation policy module manages messaging between the first computing device and second computing device based on the first conversation policy.

2. The method of claim 1, wherein the second computing device uses a second conversation policy, and wherein the first conversation policy is different than the second conversation policy.

3. The method of claim 1, wherein the first conversation policy includes a state machine identifying possible states and state transitions of a conversation during the communication.

4. The method of claim 3, wherein the state machine includes at least one state transition to a child conversation policy.

5. The method of claim 4, wherein the child conversation policy is dynamically initiated during the communication based on the at least one state transition being taken during the communication.

6. The method of claim 1, further comprising:
receiving a request to initiate a child conversation policy from the second computing device;
determining if the child conversation policy is in a local repository; and
initiating the child conversation policy if the child conversation policy is in the local repository.

7. The method of claim 6, wherein, if the child conversation policy is not in the local repository, the method further comprises acquiring the child conversation policy from one of the second computing device and a third party computing device.

8. The method of claim 7, further comprising dynamically installing and initiating the child conversation policy after acquiring the child conversation policy from one of the second computing device and the third party computing device.

9. The method of claim 3, wherein at least one state in the state machine includes one of a precondition and a postcondition for determining when a state transition is to be taken during the communication.

10. The method of claim 3, wherein:
at least one message is transmitted to the second computing device based on a current state of the communication and possible state transitions from the current state as identified by the state machine, and
at least one message received from the second computing device is processed based on a current state of the communication and possible state transitions from the current state as identified by the state machine.

11. The method of claim 1, wherein the first conversation policy is an instance of a conversation policy class.

12. The method of claim 1, wherein the first conversation policy is a modular and downloadable instance of a conversation policy class.

13. The method of claim 1, wherein communicating with the second computing device includes:
generating a process adapter for the communication, wherein the first computing device has a separate process adapter for each of a plurality of established conversations.

14. The method of claim 13, wherein generating the process adapter includes:
initiating a conversation manager that manages a conversation of the communication;
initiating a conversation support module that maintains a conversational context of the conversation; and
initiating a conversation policy handler that holds a tree of conversation policies being used in the conversation.

15. The method of claim 14, wherein the conversation support module includes an inbox and an outbox, and wherein messages directed to the first computing device for the conversation are routed to the inbox of the conversation support module.

16. The method of claim 14, wherein child conversation policies are dynamically added to the tree of conversation policies.

17. The method of claim 14, wherein conversation policies are dynamically removed from the tree of conversation policies when they are no longer being used in the conversation.

18. The method of claim 14, wherein if a message received from the second computing device is not recognizable by an active conversation policy, the message is passed up to a parent conversation policy of the active conversation policy for handling.

19. The method of claim 1, wherein communicating with the second computing device includes:
identifying the second conversation policy based on information obtained from a directory service; and
identifying the first conversation policy from a local repository, wherein the first conversation policy is identified as being compatible with the second conversation policy.

20. The method of claim 19, wherein identifying the second conversation policy based on information obtained from a directory service includes:
sending a request for information regarding the second computing device to the directory service; and
receiving a list of conversation policies compatible with the second conversation policy.

21. The method of claim 1, wherein the first conversation policy includes at least one formatting module for formatting messages to be transmitted to the second computing device, at least one parsing module for parsing messages received from the second computing device, at least one command module for invoking business logic processes, and at least one state machine for controlling messaging during the communication.

22. The method of claim 1, wherein the first conversation policy identifies other conversation policies to be used during the communication.

23. The method of claim 2, wherein the one or more criteria includes an identification of the second conversation policy.

24. The method of claim 1, wherein the one or more criteria includes one or more preferences stored in the first computing device.

25. The method of claim 24, wherein the one or more preferences includes at least one of a name of a conversation policy to load, information obtained from a previous conversation with the second computing device, and a mapping of a names of conversation policies to computing devices on a network.

26. The method of claim 1, wherein the first conversation policy identifies at least one child conversation policy that may be loaded during the communication.

27. The method of claim 1, further comprising:
acquiring a portion of the first conversation policy from one of the second computing device and a third party computing device.

28. A computer program product in a computer readable medium for communicating between a first computing device and a second computing device, comprising:
first instructions for selecting a first conversation policy from a set of conversation policies based on one or more criteria;
second instructions for loading the first conversation policy into a conversation policy module; and
third instructions for communicating with the second computing device using the conversation policy module, wherein the conversation policy module manages messaging between the first computing device and second computing device based on the first conversation policy.

29. The computer program product of claim 28, wherein the second computing device uses a second conversation policy, and wherein the first conversation policy is different than the second conversation policy.

30. The computer program product of claim 28, wherein the first conversation policy includes a state machine identifying possible states and state transitions of a conversation during the communication.

31. The computer program product of claim 30, wherein the state machine includes at least one state transition to a child conversation policy.

32. The computer program product of claim 31, wherein the child conversation policy is dynamically initiated during the communication based on the at least one state transition being taken during the communication.

33. The computer program product of claim 28, further comprising:
fourth instructions for receiving a request to initiate a child conversation policy from the second computing device;
fifth instructions for determining if the child conversation policy is in a local repository; and
sixth instructions for initiating the child conversation policy if the child conversation policy is in the local repository.

34. The computer program product of claim 33, wherein, if the child conversation policy is not in the local repository, the computer program product further includes seventh instructions for acquiring the child conversation policy from one of the second computing device and a third party computing device.

35. The computer program product of claim 34, further comprising eighth instructions for dynamically installing and initiating the child conversation policy after acquiring the child conversation policy from one of the second computing device and the third party computing device.

36. The computer program product of claim 30, wherein at least one state in the state machine includes one of a precondition and a postcondition for determining when a state transition is to be taken during the communication.

37. The computer program product of claim 30, wherein:
at least one message is transmitted to the second computing device based on a current state of the communication and possible state transitions from the current state as identified by the state machine, and
at least one message received from the second computing device is processed based on a current state of the communication and possible state transitions from the current state as identified by the state machine.

38. The computer program product of claim 28, wherein the first conversation policy is an instance of a conversation policy class.

39. The computer program product of claim 28, wherein the first conversation policy is a modular and downloadable instance of a conversation policy class.

40. The computer program product of claim 28, wherein the third instructions for communicating with the second computing device includes:
instructions for generating a process adapter for the communication, wherein the first computing device has a separate process adapter for each of a plurality of established conversations.

41. The computer program product of claim 40, wherein the instructions for generating the process adapter includes:
instructions for initiating a conversation manager that manages a conversation of the communication;
instructions for initiating a conversation support module that maintains a conversational context of the conversation; and
instructions for initiating a conversation policy handler that holds a tree of conversation policies being used in the conversation.

42. The computer program product of claim 41, wherein the conversation support module includes an inbox and an outbox, and wherein messages directed to the first computing device for the conversation are routed to the inbox of the conversation support module.

43. The computer program product of claim 41, wherein child conversation policies are dynamically added to the tree of conversation policies.

44. The computer program product of claim 41, wherein conversation policies are dynamically removed from the tree of conversation policies when they are no longer being used in the conversation.

45. The computer program product of claim 41, wherein if a message received from the second computing device is not recognizable by an active conversation policy, the message is passed up to a-parent conversation policy of the active conversation policy for handling.

46. The computer program product of claim 28, wherein the third instructions for communicating with the second computing device includes:
instructions for identifying the second conversation policy based on information obtained from a directory service; and
instructions for identifying the first conversation policy from a local repository, wherein the first conversation policy is identified as being compatible with the second conversation policy.

47. The computer program product of claim 46, wherein the instructions for identifying the second conversation policy based on information obtained from a directory service includes:
instructions for sending a request for information regarding the second computing device to the directory service; and
instructions for receiving a list of conversation policies compatible with the second conversation policy.

48. The computer program product of claim 28, wherein the first conversation policy includes at least one formatting module for formatting messages to be transmitted to the second computing device, at least one parsing module for parsing messages received from the second computing device, at least one command module for invoking business logic processes, and at least one state machine for controlling messaging during the communication.

49. The computer program product of claim 28, wherein the first conversation policy identifies other conversation policies to be used during the communication.

50. The computer program product of claim 29, wherein the one or more criteria includes an identification of the second conversation policy.

51. The computer program product of claim 28, wherein the one or more criteria includes one or more preferences stored in the first computing device.

52. The computer program product of claim 51, wherein the one or more preferences includes at least one of a name of a conversation policy to load, information obtained from a previous conversation with the second computing device, and a mapping of a names of conversation policies to computing devices on a network.

53. The computer program product of claim 28, wherein the first conversation policy identifies at least one child conversation policy that may be loaded during the communication.

54. The computer program product of claim 28, further comprising:
fourth instructions for acquiring a portion of the first conversation policy from one of the second computing device and a third party computing device.

55. An apparatus for communicating between a first computing device and a second computing device, comprising:
means for selecting a first conversation policy from a set of conversation policies based on one or more criteria;
means for loading the first conversation policy into a conversation policy module; and
means for communicating with the second computing device using the conversation policy module, wherein the conversation policy module manages messaging between the first computing device and second computing device based on the first conversation policy.
